(19) United States
(12) Patent Application Publication
(10) Pub. No.: US 2015/0337975 A1
(43) Pub. Date: Nov. 26, 2015

(54) INFLATION VALVE CAP APPARATUS AND METHOD

(71) Applicant: Charles Allen, Hurricane, WV (US)

(72) Inventor: Charles Allen, Hurricane, WV (US)

(21) Appl. No.: 14/791,452

(22) Filed: Jul. 5, 2015

Related U.S. Application Data
(63) Continuation-in-part of application No. 14/122,000, filed on Nov. 13, 2014.
(60) Provisional application No. 61/997,173, filed on May 23, 2014.

(51) Int. Cl. F16K 15/20

(52) U.S. Cl. CPC F16K 15/205

(57) ABSTRACT

An inflation valve cap having a cap body, an ear depending from the cap body, and a valve body for inflating or pressurizing a beverage bottle. A locking washer may be provided to prevent the valve body from ejecting from the cap body.

### PRIOR APPLICATION

This is a continuation in part application of application Ser. No. 14/122,000, filed Nov. 13, 2014, which claims the benefit of U.S. Provisional Application No. 61/997,173, filed May 23, 2014, the disclosures of which are hereby incorporated by reference in its entirety.

### FIELD OF THE INVENTION

The present application discloses and describes an inflation valve cap, and in particular, an Inflation. valve cap for use with a plastic beverage bottle to allow pressurization of the beverage bottle with air for repurposed use thereof.

### BACKGROUND OF THE INVENTION

The National Shooting Sports Foundation (“NSSF”) reports that about 20.2 million target-shooting enthusiasts spend approximately $493 per person, or $9.9 billion per year in total, and inject approximately $23 billion into the national economy

http://ww.nssf,org/PDF/research/TargetShootingInAmericaReport.pdf However, the NSSF also reports that target shooting participation falls off significantly when target ranges are located more than 30 minutes away from enthusiasts. This is a particularly acute problem in rural areas where the populations are scattered outside of densely populated areas and away from the economic centers that generally have such target-shooting facilities, thereby increasing travel time and costs dedicated to such recreational activities and/or causing discouragement in pursuing such opportunities altogether.

In an attempt to counteract these effects, target-shooting equipment is available in sporting goods stores that allow enthusiasts to attempt simulation of the shooting range experience. However, expense to the individual enthusiast becomes a concern, especially considering individuals rarely purchase equipment and materials in bulk quantities at the discounted rates that is often available to commercial shooting range facilities.

One means of addressing expense is through the use of reactive targets, which often explode upon impact. Moreover, user adoption of “plinking” in which nonstandard targets are utilized, as means for simulating or replicating shooting range targets and the reactive nature of such targets. Usually, the “target” is an object made from metal wood, glass, plastic, paper, or other similar material, and is often an object that has been previously damaged, reached a state of obsolescence, or is repurposed for an unintended use. However, certain types of “flat” objects fail to fully replicate the sound and experience one achieves on a range.

Accordingly, there is a need for easily-assembled repurposed objects and materials that may be utilized as “plinking” (reactive) targets to simulate shooting range targets and conditions that is also cost effective and provides additional modes of feedback to enhance the excitement and fun of target shooting that might not otherwise be attained under similar circumstances.

Accordingly, there is an unresolved need for easily-assembled, repurposed objects and materials that may be utilized, as “plinking” targets that may be used repeatedly to conserve materials and reduce costs.

### SUMMARY OF THE INVENTION

Example embodiments provide an inflation valve cap having a cap body with an aperture, an ear depending from the cap body, and a valve body having a bore and perforation, and the aperture, bore, and perforation re arranged in coaxial alignment. The cap body may Include a plurality of internal threads for threaded coupling with a threaded beverage bottle neck or throat.

In one embodiment, the valve body includes a flange, a bulb, and a stem intermediately disposed therebetween, the valve body having a bore and a perforation in coaxial alignment, the bore traversing the flange, stem, and a portion of the bulb, and the perforation traversing from the terminus of the bore to the margin of the bulb.

In another embodiment, the valve body includes a flange, a bulb, and a stem, the flange intermediately disposed therebetween, the valve body having a bore and. a perforation in coaxial alignment, the bore traversing the flange, stem, and a portion of the bulb, and the perforation traversing from the terminus of the bore to the margin of the bulb.

In another embodiment, the valve body includes a neck, a flange, a conical portion, and a stem, the flange intermediately disposed therebetween, the valve body having a bore and a perforation in coaxial alignment, the bore traversing the flange, stem, aid a portion of the conical portion, and the perforation traversing from the terminus of the bore to the margin of the conical portion. A locking washer may be provided, the washer having an aperture receiving the neck of valve body, and the washer affixed flush against the cap body.

It is envisioned that another embodiment comprises a method of using an inflation valve cap having a cap body, an ear depending from the cap body, and a valve body, the method comprising the steps of ensuring the valve body is mostly inserted into the throat of a beverage bottle, threading the cap body onto the neck of the beverage bottle, tethering the ear, inserting an inflation needle through the cap body and valve body, inflating the beverage bottle to a sufficient air pressure, and removing the inflation needle from the cap body and the valve body. It is further envisioned that an additional step of targeting the beverage bottle with a weapon may be included.

### BRIEF DESCRIPTION OF THE DRAWINGS

FIG. 1 illustrates one embodiment of an inflation valve cap in exploded view for use with a beverage bottle and an inflation device;

FIG. 2 illustrates one embodiment of the cap body and valve body in cut-away;

FIG. 3 illustrates one embodiment of the cap body; and

FIG. 4a illustrates one embodiment of the valve body; and

FIG. 4b illustrates another embodiment of the valve body;

FIG. 5A illustrates another embodiment of the cap body, ear, and valve body in cut-away;

FIG. 5B Illustrates the embodiment depleted in FIG. 5A;

FIG. 6A illustrates another embodiment of the cap body, ear, and valve body in cut-away;

FIG. 6B illustrates the embodiment depicted in FIG. 6A;

FIG. 7 illustrates another embodiment of the cap body, ear, and valve body; and

FIG. 8 illustrates another embodiment of the cap body, ear, and valve body, including a locking washer.

### DESCRIPTION OF THE EMBODIMENTS

It will be readily understood that the components of the present invention, as generally described and illustrated in the figures herein, may be arranged, and designed in a wide variety of different configurations. Thus, the following detailed description of the embodiments as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined hi any suitable manner in one or more embodiments.

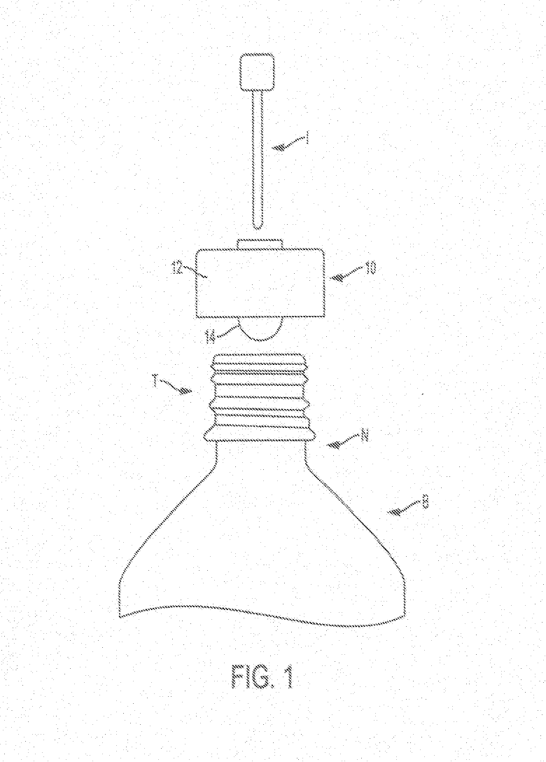

In accordance with the drawings illustrating at least one embodiment of an inflation valve cap for use on a threaded bottle, as generally depicted in FIG. 1 through FIG. 8, an inflation valve cap 10 is depicted as including a cap body 12 and a valve body 14, and an ear 22 depending from the cap body 12. The cap body 12 houses the valve body 14. The cap body 12 includes an aperture 16 in coaxial alignment with a mutually coaxial bore 18 and perforation 20 disposed within the valve body 14. The cap body 12 includes the ear 22 depending from the cap body 12, described in greater detail below. The cap body 12 includes internal threads for threaded coupling with the threaded neck of a beverage bottle. It is envisioned that all sizes of beverage bottle and cap may be adapted for use In the manner described herein.

The cap body 12 may be constructed from a variety of materials, including many plastics or elastomeric material. It is envisioned that materials presently used is industrial manufacturing of plastic bottle caps will be utilized to take advantage of economies of scale and preexisting technology and techniques. Accordingly, it is envisioned that cap bodies will be manufactured from polyethylene or polypropylene, a thermoplastic material used in the manufacture of plastic containers and bottles. However, other similarly suitable thermoplastic polymers capable of sustaining stretching and blow molding techniques are contemplated as within the scope of the embodiments.

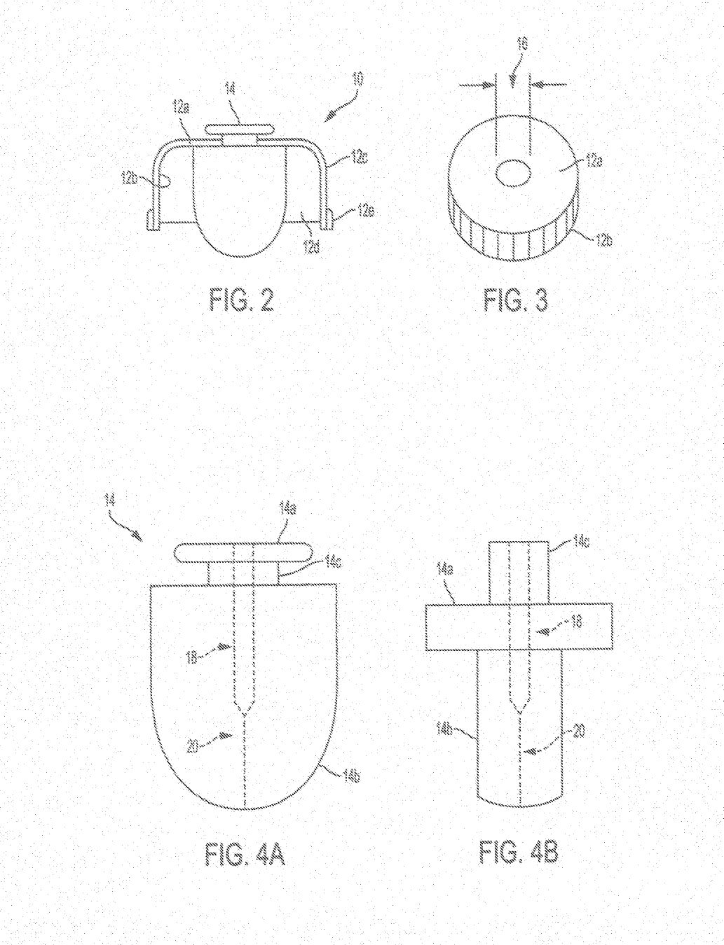

As depicted in FIG. 2 and FIG. 3, the cap body 12 may comprise a wall 12a having a depending wall 12b circumscribing the exterior margin of wall 12a, and thereby forming an outer surface 12c and an inner surface 12d. The wall 12b may be integral and mutually coterminous to wall 12a. The outer surface 12c may comprise a knurled or ridged arrangement providing means for a user to securely grasp and rotate for threading and unthreading the cap body 12 to and from a threaded bottle neck. In one embodiment, the inner surface 12d may comprise multiple threads complementary to the external threads provided on the bottle neck. In another embodiment, it is envisioned that the cap body 12 may be secured by force impingement using a variety of known means, and through the pressurization of the bottle, the cap body 12 will securely bold to the bottle neck. A reinforced skirt 12e may circumscribe the free terminus of wall 12b that opposes the coterminous junction of walls 12a and 12b.

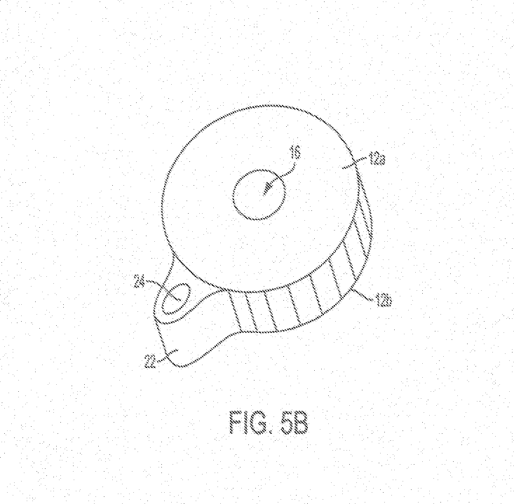

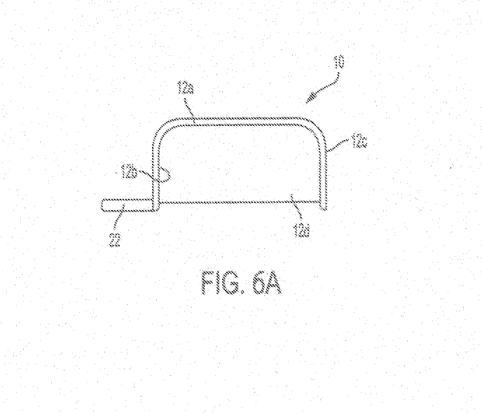

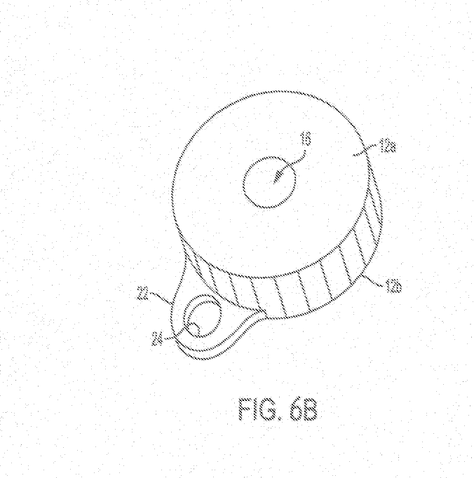

As depicted in FIGS. 5A and 5B through FIGS. 6A and 6B, the cap body 12 may comprise an ear 22 depending from the tree terminus of the body 12. The ear 22 (and tethering aperture 24) may be utilized for tethering the cap body 12 to another object to prevent the cup body 12 from being irretrievably lost and/or destroyed through a projectile piercing the bottle B and causing an impact explosion. In one embodiment, an arm, string, cord, bungee, or other similar material and/or instrument or implement may be used by inserting such material through, the tethering aperture 24 and securing the opposing end(s) to another object including any semi-permanent or permanent structures that will keep the cap body 12 within a defined range post impact and explosion caused by the piercing of the bottle B.

Several forms and locations of the ear 22 (and tethering aperture 24) are contemplated. For example, the cap body 12 may be formed by a top wall 12a and a downwardly depending wall 12b circumscribing the exterior margin of top wall 12a, and therefore, the ear 22 may depend from the free terminus of wall 12b. In one embodiment, such as FIGS. 5A and 5B, it is envisioned that the cap body 12 may omit a reinforced skirt 12e and the ear 22 may instead depend from the region along the free terminus of wall 12b. In another embodiment, it is envisioned that, the ear 22 may depend from the reinforced skirt 12e circumscribing the free terminus of wall 12b. In another embodiment, it is envisioned that the ear 22 may depend from just above the reinforced skirt 12e.

As depleted in FIGS. 5A and 5B, the ear 22 and tethering aperture 24 may be arranged to traverse the cap height. A taller or thicker ear 22 (and corresponding aperture 24) may provide greater structural integrity, rigidity, and necessary flexibility to the ear 22 and prevent the ear 22 and/or cap body 12 from being damaged by the forces placed on the cap body 12 from a projectile piercing the bottle B. Alternatively, as depleted in FIGS. 6A and 6B, the ear 22 and tethering aperture 24 may be arranged to have a lower profile, traversing only a portion of the cap height.

The ear 22 may comprise a substantially planar form. In one embodiment, a tethering aperture 24 is formed and disposed within the ear 22. In another embodiment, the ear 22 may comprise a returnably resilient material along a length of the planar form. The returnably resilient material may be included only at the junction between the ear 22 and the cap body 12, or may be included along tire entire length of the ear 22, or may be along a length intermediate to the junction and the entire length of the ear 22. The returnably resilient material provides flexibility and nominal rigidity to prevent breaking of the ear 22 and/or other constituent parts or portions of the cap body 12 and/or apparatus 10. The returnably resilient material also allows the ear 22 to be manipulated when necessary for coupling with, a tethering arm, cord, or other instrument.

The cap body 12 may comprise an aperture 16 formed through the wall 12a. The aperture 16 may comprise a plurality of dimensions. In particular, the aperture 16 may be generally arranged in coaxial alignment with the bore 18 and perforation 20 formed in the valve body 14, discussed in greater detail below, although precise coaxial alignment is not required, so long as an inflation needle can traverse the aperture 16 and into the bore 18 and perforation 20. The aperture 16 may be formed during the molding process of the cap body 12 or may be formed post-molding. In one embodiment, the aperture 16 may retain the valve body 14, and in particular, may retain the valve body 14 so that a portion of the valve body 14 resides opposite to and concentrically within the inner surface 2d of the cap body 12.

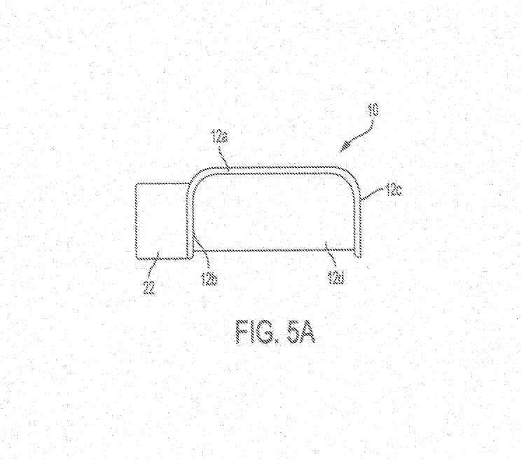

As depicted in FIG. 4a, the valve body 14 may be constructed from a variety of materials, including natural or synthetic rubbers (e.g., polymeric elastomers), so long as tire material(s) is/are resilient, flexible, and durable. It is envisioned that one embodiment, of the valve body 14 comprises a toroidal or annular flange, or umbrella, 14a, a bulbous pardon 14b, and an intermediately disposed stem 14c. The bore 18 is concentric to the flange 14a, bulbous 14b, and stem 14c portions, and therefore generally concentric to the valve body 14 as a whole. The bore 18 penetrates or traverses the flange 14a portion and the stem 14c portion, and partially penetrates or traverses the bulbous portion 14b. A perforation 20 begins at the terminus of the bore 18 and continues to the exterior margin of the bulbous portion 14b. The perforation 20 forms a substantially impermeable seal within the valve body 14 so that no appreciable quantity of air, liquid, or other media or material digresses or egresses the perforation 20. The bore 18 is adapted to receive and retain an inflation needle from a hand pump, pneumatic pump, compressor, or other similar inflation device. The perforation 20 is adapted to displace when the inflation needed is inserted therethrough, and to retain the inflation needle during the inflation process. After the inflation needle is removed from the perforation 20, the material urges return of the perforation to an initial state of being a substantially impermeable barrier, and thereby preventing media ingress or egress across the perforation 20.

In another embodiment, as depicted in FIG. 4b, the valve body 14 comprises a toroidal flange or umbrella 14a intermediately disposed between a bulbous portion 14b and a stem 14c. The bore 18 is concentric to the bulbous 14b, flange 14a, and stem 14c portions, and therefore generally concentric to the valve body 14 as a whole. The bore 18 penetrates or traverses the flange or umbrella 14a portion and the stem 14c portion, and partially penetrates or traverses the bulbous portion 14b. A perforation 20 begins at the terminus of the bore 18 and continues to the exterior margin of the bulbous portion 14b.

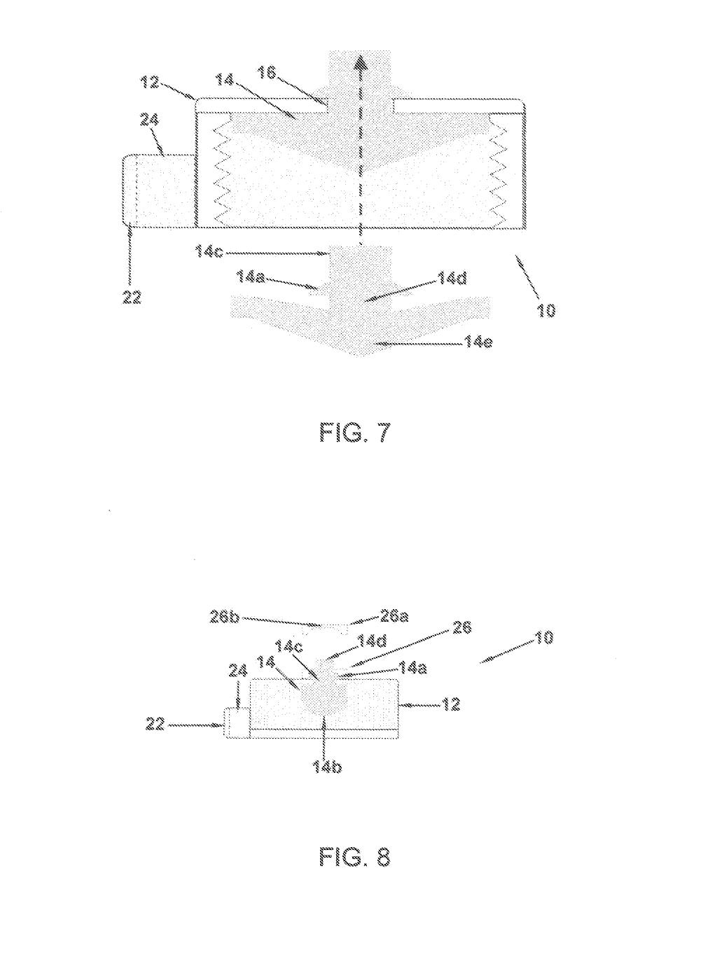

As depicted in FIG. 7, it is also envisioned that the cap 10 comprises a cap body 12, a valve body 14 installed through the cap body 12 with an flange or umbrella 14a disposed flush-against the top surface of the cap body 12 and forming a seal. The cap body 12 may also include an ear 22 with tethering aperture 24. The valve body 14 comprises a flange or umbrella 14a intermediately disposed between the stem 14c and an elongated neck 14d. The stem Me is intermediately disposed between the flange or umbrella 24 and the conical portion 140.

The valve body 14 is inserted through the cap body 12 via the aperture 16 in the cap body 12. The valve body 14 is inserted through the underside of the cap body 12 and aperture 16 so mat the flange or umbrella 14a and neck 14d are exposed through the top surface of the cap body 12. The stem 14c and conical portion 14e of the valve body 14 are exposed on the underside of the cap body 12. The stem 14c substantially fills the aperture 16 in cap body 12. The flange or umbrella 14a sets flush-against the top surface of the cap body 12. The underside of the conical portion 14c sets flush-against the underside of the cap body 12. Together, the flange/umbrella 14a, the stem 14c, and the underside of the conical portion 140 form a seal that assists in pressurizing the beverage container the cap 10 is attached. In addition, the flange/umbrella 14a, the stem 14c, and the conical portion 14e work together to prevent the valve body 54 from being elected from the cap boy 12 and/or the beverage container after ammunition strikes the beverage container. By preventing the ejection of the valve body 14 from the cap 10 and cap body 12, the cap 10 and its components may be used multiple times, thereby reducing costs to fire-arms enthusiasts.

As depicted in FIG. 8, it is also envisioned that the cap 10 comprises a cap body 12, a valve body 14 installed through the cap body 12, an ear 22 with tethering aperture 24, and a locking washer 26 applied to the top of the valve body 14 and against the top of the cap body 12. Similar to the valve body 14 illustrated and described in relation to FIG. 7, the valve body 14 comprises a flange or umbrella 14a, a stem 14c, a bulbous portion 14b, and a neck 14d. The flange or umbrella 14a rests flush-against the top surface of the cap body 12, with the neck 14d upwardly extending therefrom. The neck 14d provides a support by which the locking washer 26 is attached. The stem 14c is intermediately disposed between the flange or umbrella 14a and the bulbous portion 14b.

The locking washer 26 comprises an annular body 26a with an aperture 26b formed therethrough. The aperture 26b recedes the neck 14d portion of valve body 14. The annular body 26a envelopes the flange or umbrella 14a of valve body 14. It is envisioned that the locking washer 26 may be force-impinged onto the neck 14d and flange/umbrella 14a. It is also envisioned that the locking washer 26 may be adhered to the top surface of the cap body 12 and/or the flange/umbrella 14a. Regardless of the means or mechanism of attachment, the locking washer 26 provides additional support against the ejection of the valve body 14 from the cap body 12 after ammunition, strikes the beverage container.

It is envisioned that the valve body 34 may be integral to the cap body 12 so that a portion of the valve body 14 resides on one side of aperture 16 and another portion of valve body 14 resides on the opposing side of aperture 16. In this arrangement, the valve body 14 may be formed concurrent with or sequentially to the formation of the aperture 16 in cap body 12. In another embodiment, it is envisioned that valve body 14 and cap body 32 are separate components that may be coupled, through compression or impingement of the valve body 14 by the cap body 12 (using the threaded coupling of the cap body 12 to the threaded neck of the beverage bottle).

It is envisioned that the inflation valve cap may be sold as a part of a kit. In one embodiment, the kit includes packaging and a plurality of inflation valve caps 10 contained in the packaging. In another embodiment, the kit includes packaging, a plurality of inflation valve caps 10, and instructions for use. In another embodiment, the kit includes packaging, instructions for use, and a plurality of inflation valve caps 10 comprising an integral cap body 12, a tethering ear 22, and valve body 14. In another embodiment, a locking washer 26 (consistent with that disclosed above) is utilized to further secure the valve body 14 to the cap body 12. In another embodiment, the kit includes packaging, instructions for use, and plurality of inflation valve caps 10 comprising a cap body 12 separate from the valve body 14. In another embodiment the kit includes packaging, instructions for use, and a plurality of inflation valve caps comprising at least one integral cap body 12 and valve body 14 and at least one separate cap body 12 and one separate valve body 14.

In use, the inflation valve cap 10 may be installed on a plastic beverage bottle (B). Ensuring that the valve body 14 will at least partially reside in the throat (T) of the beverage bottle (B) neck (N), the cap body 12 may be threaded onto the neck (N) of the bottle (B). The tethering ear 22 may be secured so that a tethering arm, cord, or other such instrument may be coupled through the aperture 24 of the ear 22 and secure the cap body 12 to prevent loss. An inflation needle (I) may be inserted through the aperture 16 (of cap body 12) and through bore 18 and perforation (of valve body 14) so that the terminus of the inflation needle (I) is in fluid communication with the interior volume of the beverage bottle (B). Thereafter, a pump may be used to direct air from the pump, through the needle, and into the interior volume of beverage bottle (B). Once the beverage bottle (B) is sufficiently filled with air, the inflation needle (I) may be removed, thereby sealing the air and any other media within the beverage bottle (B). The beverage bottle (B) may be positioned or staged as desired for target shooting. A weapon may be used to propel a projectile at the beverage bottle (B) target with the intention of rupturing the beverage bottle (B). It is envisioned that a weapon may comprise a variety of instruments, including traditional firearms, high-powered air-guns, compressed air or CO₂-powered BB or pellet guns, crossbows, longbows, sling-shots, or other similar instruments.

It is envisioned that another useful step includes the addition of water, with or without coloring, to approximately ¼ to ⅓ of the total volume of the beverage bottle (B). Providing a water-based medium allows the user to invert the beverage bottle (B) from its typical orientation, including placement in a base suitable for holding the neck (N) of the beverage bottle (B). In addition, it is believed that the addition of a water-based medium for Inverted-staging of the beverage bottle (B) insulates the inflation valve cap 10 from damage and extends the useful life of the cap 10 for additional uses. It is further envisioned that other suitable fluid material may be used to infill the internal volume of the beverage bottle.

It is further envisioned that a powder-media may be used to fill the interior volume of the beverage bottle (B) to safely replicate the shooting range experience. For example, at some shooting ranges, tannerite is used to generate flash explosions and smoke to indicate to a shooter that s/he has hit the target. Tannerite comprises two inert materials that when combined are poised to explode and smoke upon contact by a bullet or round of ammunition. To avoid using potentially explosive materials, and since flat objects do not receive and retain powder easily, the use of powder (e.g., talc) within the interior volume of a beverage bottle (B) provides a safe and fun alternative as a means for indicating the target has been successful struck during target practice.

Although the inflation valve cap 10 has been generally described for recreational use apart from a traditional target shooting range, it is envisioned that a commercial shooting range may use and incorporate such devices, apparatuses, methods, and concepts as well, therefore, all the descriptions and examples should be understood as broadly applying to uses at commercial shooting ranges and off-site on the personal property of target shooting enthusiasts and the like, and unless otherwise stated, no limitation should be interpreted or implied. Moreover, it is further contemplated that the cap(s) 10 may be installed on beverage bottles that may then be carried, supported, suspended, or otherwise flown or transported by a mobile transport, such as a carrier drone or other similar article or vehicle.

For example, a commercial shooting range or a properly owner could collect and repurpose commercially sold plastic beverage bottles (B) for targets as generally described above. The ubiquity of 3-liter, 2-liter, 3-liter, 24-, 16-, and 8-ounce bottles, and other such containers, allow the range or owner to mix and match a plurality of variously sized beverage bottles (B) for competition-style coarse arrangements, since the large bottles will be easier to see and strike and the smaller bottles more challenging. Avoiding redundancy in the type of target utilized for practice Is often a key aspect in maintaining the interest of novice target shooters.

After the beverage bottles (B) have been struck, the plastic fragments may be collected and shipped to a recycling center, thereby providing the added advantage of recycling such bottles or containers and advancing the recycling step by initially breaking down the bottles Into smaller fragments. Furthermore, the incorporation of the tethering ear 22 allows the cap body 12 and apparatus 10, generally, to be secured In a way that the apparatus 10 and components (e.g., cap body 12 and valve 14) are not lost and damaged due to the explosive forces imparted on all the elements when the projectile strikes the bottle B, creating an impact and explosion. In particular, the tethering article or instrument may be tied around the cap and hound to and through the ear and then partially secured in the beverage container to prevent ejection beyond the target area.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed, herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. An inflation valve cap comprising:
a cap body having an aperture;
an ear depending from the cap body;
a valve body having a bore and perforation; and
the aperture, bore, and perforation arranged in coaxial alignment.

2. The inflation valve cap of claim 1, wherein the cap body comprises a top wall circumscribed by a downwardly depending wall, the aperture formed through the top wall.

3. The inflation valve cap of claim 2, wherein the ear depends from the downwardly depending wall.

4. The inflation valve cap of claim 3, wherein the ear comprises a tethering aperture.

5. The Inflation valve cap of claim 2, wherein the ear comprises flexible returnably resilient material.

6. The inflation valve cap of claim 2, wherein the cap body further comprises a reinforced skirt circumscribing the free terminus of the downwardly depending wall.

7. The inflation valve cap of claim 6, wherein the ear depends from the skirt circumscribing the downwardly depending wall.

8. The Inflation valve cap of claim 6, wherein the ear comprises flexible returnably resilient material.

9. The inflation valve cap of claim 1, wherein the cap body further comprises internal threads.

10. The inflation valve cap of claim 1, wherein the bore is adapted to receive an inflation needle.

11. The inflation valve cap of claim 1, wherein the valve body further comprises:
a valve body having a flange, a bulb, and a stem intermediately disposed therebetween, the valve body having a bore and a perforation in coaxial alignment, the bore traversing the flange, stem, and a portion of the bulb, and the perforation traversing from the terminus of the bore to the margin of the bulb.

12. The inflation valve cap of claim 11, the bore and the perforation in fluid communication with the interior volume of a beverage bottle.

13. The inflation valve cap of claim 1, wherein the valve body further comprises;
a valve body having a flange, a bulb, and a stem, the flange intermediately disposed therebetween, the valve body having a bore and a perforation in coaxial alignment, the bore traversing the flange, stem, and a portion of the bulb, and the perforation traversing from the terminus of the bore to the margin of the bulb.

14. The inflation valve cap of claim 13, the bore and the perforation in fluid communication with the interior volume of a beverage bottle.

15. The inflation valve cap of claim 1, wherein the valve body further comprises:
a valve body having a neck, a flange, a conical portion, and a stem, the flange intermediately disposed therebetween, the valve body having a bore and a perforation in coaxial alignment, the bore traversing the neck, the flange, the stem, and a portion of the conical portion, and the perforation traversing from the terminus of the bore to the margin of the conical portion.

16. The inflation valve cap of claim 15 further comprising a locking washer.

17. The inflation valve cap of claim 16, wherein the locking washer receives the neck of the valve body and is affixed to the cap body.

18. A method of using an inflation valve cap having a cap body, an ear depending from the cap body, and a valve body, the method comprising the steps of:
ensuring the valve body is mostly inserted into the throat of a beverage bottle;
tethering the cap body via the ear;
threading the cap body onto the neck of the beverage bottle;
inserting an inflation needle through the cap body and valve body;
inflating the beverage bottle to a sufficient air pressure; and
removing the inflation needle from the cap body and the valve body.

19. The method of claim 15, further comprising the step of: adding a fluid material to the beverage bottle.

20. The method of claim 15, further comprising the step of: adding a powder material to the beverage bottle.
